(19) United States
(12) Patent Application Publication
(10) Pub. No.: US 2007/0012266 A1
(43) Pub. Date: Jan. 18, 2007

(54) Cord starter

(76) Inventor: Bengt-Olov Westerlund, Ope (SE)

Correspondence Address: YOUNG & THOMPSON, 745 SOUTH 23RD STREET, 2ND FLOOR, ARLINGTON, VA, 22202, US

(21) Appl. No.: 11/487,477

(22) Filed: Jul. 17, 2006

Related U.S. Application Data
(60) Provisional application No. 60/701,027, filed on Jul. 21, 2005.

(30) Foreign Application Priority Data
Jul. 18, 2005 (SE) 0501697-7

(51) Int. Cl. F02D 27/00; F02N 3/02

(52) U.S. Cl. 123/41 R; 123/185.3

(57) ABSTRACT

A recoil starter comprising a housing (1) that is stationary mounted relative to an engine; a moving unit rotatable about a stationary axis (8) of rotation in the housing, the moving unit comprising a line pulley (2) onto which a pulling line (3) is winded, an inner end of the pulling line being anchored near a centre of the line pulley (2) and an outer, free end of which reaches through an aperture formed through a wall of the housing (1); a return spring (4) connected to the line pulley (2), said return spring arranged to be stretched by the line pulley when the line pulley is rotated about said axis (8) in result of pulling the pulling line (3) off from the line pulley, and which is operative upon return to rewind the pulling line onto the line pulley; a carrier (6) driven by said line pulley for rotation about said stationary axis (8); a swinging pawl (5) supported on the carrier (6), said pawl driven by said carrier in rotation to engage a crank shaft of the engine for transferring upon said crank shaft the rotation of said carrier (6), and which pawl returns to a non-engaging position on said carrier when the rotational speed of the crank shaft exceeds the rotational speed of the carrier upon ignition of the engine. The carrier is shiftable from contra-rotation to co-rotation with the line pulley and vice versa, and the carrier carries at least two pawls, each of which is operative in one of said co-rotational and contra-rotational directions.

### TECHNICAL FIELD

The present invention refers to a recoil starter for an internal combustion engine, and more specifically to a recoil starter which is reversible for starting the engine in one direction of rotation or the other.

### BACKGROUND AND PRIOR ART

Start devices of the type referred to are commonly used for the starting of engines in motorized tools and vehicles. The invention originates from a desire to be able to reverse the rotational direction of an engine that lacks a reverse gear. As a typical example the application may be implemented in a snowmobile, however the invention is not limited thereto.

Prior art solutions involve, for example, ignition systems which are controlled during operation of the engine at a low rpm to discharge a spark of ignition at a point of time sufficiently in advance of the upper dead centre so as to urge the engine into a reversed rotation, see e.g. U.S. Pat. No. 5,794,574 and U.S. Pat. No. 5,782,210. The ignition control may also be assisted by a control of inlet valves and outlet valves, see e.g. U.S. Pat. No. 6,647,933.

A problem which is common to these known methods is that reversing the rotational direction of a running engine generates a heavy mechanical load on moving parts and bearings.

### SUMMARY OF INVENTION

The present invention has for an object to provide a solution which avoids applying any additional load on the engine upon reversing the engine's general direction of rotation, above the loads that may be expected during normal operation of the engine.

This object is met in a recoil starter for starting an engine in alternative directions of rotation, as recited in the appended claims.

A recoil starter according to the invention briefly comprises:
a housing that is stationary mounted relative to an engine;
a moving unit rotatable about a stationary axis of rotation in the housing, the moving unit comprising a line pulley onto which a pulling line is winded, an inner end of the pulling line being anchored near a centre of the line pulley and an outer, free end of which reaches through an aperture formed through a wall of the housing; a return spring connected to the line pulley, said return spring arranged to be stretched by the line pulley when the line pulley is rotated about said axis in result of pulling the pulling line off from the line pulley, and which is operative upon return to rewind the pulling line onto the line pulley; a carrier driven by said line pulley for rotation about said stationary axis; a swinging pawl supported on the carrier, said pawl driven by said carrier in rotation to engage a crank shaft of the engine for transferring upon said crank shaft the rotation of said carrier, and which pawl returns to a non-engaging position on said carrier when the rotational speed of the crank shaft exceeds the rotational speed of the carrier upon ignition of the engine, wherein the carrier is shiftable from contra-rotation to co-rotation with the line pulley and vice versa, and the carrier carries at least two pawls, each of which is operative in one of said co-rotational and contra-rotational directions.

In the illustrated and preferred embodiment the carrier is axially displaceable along said axis of rotation, and in a first position of displacement operatively connectable to the line pulley in a co-rotating relation via a mechanical coupling, and in a second position of displacement operatively connectable to the line pulley in a contra-rotating relation via a transmission gear.

The recoil starter comprises a hollow shaft which is journalled for rotation about the stationary axis, said shaft having a first end carrying the line pulley and a second end carrying a holder, wherein the carrier is rotatably supported for sliding on said shaft between the line pulley and the holder, and wherein the carrier is connectable to the line pulley, on one hand, via the transmission gear which is positioned between the carrier and the line pulley and operative for connecting the carrier to the line pulley in a contra-rotational relation, and on the other hand via the mechanical coupling which is positioned between the carrier and the holder and operative for connecting the carrier to the line pulley in a co-rotational relation.

Further advantageous embodiments of the invention are defined in the subordinated claims.

### SHORT DESCRIPTION OF THE DRAWINGS

The invention is more closely explained below with reference being made to the drawings, showing diagrammatically an embodiment of the invention.

FIG. 1 is a longitudinal section through the apparatus as shifted for starting an engine in a first direction of rotation, and

FIG. 2 is corresponding sectional view showing the apparatus shifted for starting the engine in a second, reverse direction of rotation.

### DETAILED DESCRIPTION OF PREFERRED EMBODIMENTS

The recoil starter comprises a housing 1 which is stationary mounted to an engine, and in the housing a movable unit which is mounted for rotation in the housing 1 about an axis of rotation. The movable unit comprises a line pulley 2, onto which a pulling line 3 is winded. A first or inner end of the pulling line is anchored near a centre of the line pulley, and a second, outer free end of the pulling line reaches out of the housing through an aperture formed in a wall of the housing. The line pulley 2 is connected to a return spring 4 which is arranged to be stretched by the line pulley in result of pulling the pulling line 3. The return spring 4 is then operative for returning the line pulley to the initial position when the pulling is released, rewinding the pulling line onto the line pulley. The rotation of the line pulley is transferred upon an engine crank shaft via a pawl 5 or other gripping element, the pawl or pawls pivotally arranged on a carrier 6 which rotates about the rotational axis. Upon rotation, the carrier 6 brings the pawl 5 into engagement, directly or indirectly, with the crank shaft. As the rotational speed of the crank shaft exceeds the rotational speed of the carrier upon ignition of the engine, the pawl is returned to a non-engaging position on said carrier.

According to the invention, the carrier 6 is shiftable for rotation in the rotational direction of the line pulley 2 or alternatively in a direction reversed thereto, and at least two pawls 5,5′, each effective in one of said directions of rotation, are supported on the carrier.

For this purpose, the carrier 6 is axially displaceable along its rotational axis, and in a first position of displacement connected to the line pulley via a mechanical coupling in a co-rotational engagement with the line pulley. In a second position of displacement on the rotational axis, the carrier 6 is connected to the line pulley via a transmission gear, in a contra-rotational engagement.

More precisely, the line pulley 2 is attached near to a first end of a hollow shaft 7 which is carried for rotation about a stationary axis 8 of rotation, the axis 8 being stationary supported in the housing 1. In that end of shaft 7 which is remote from the line pulley, a disc-shaped holder 9 is non-rotationally attached to the shaft 7, the holder 9 thus co-rotating with the line pulley 2 upon pulling the pulling line 3. In the illustrated embodiment, the holder 9 is inserted onto a tap end 10 formed with planar sides in the second end of the shaft 7. The holder 9 is axially arrested on the shaft 7 by means of a washer 11 and a nut 12, screwed into the end of stationary axis B. The holder 9 thus rotates with the shaft 7 relative to the washer 11, the latter preferably being stationary relative to the axis 8.

Interconnecting elements 13, such as one or several heels shaped for insertion into corresponding recesses formed on the carrier 6, are arranged in that side of the holder 9 which faces the carrier 6. The carrier 6 is supported on the shaft 7 and rotatable relative thereto, and axially displaceable along the shaft 7 to be detachably engaged by the interconnecting elements 13. In result of this engagement the carrier 6, the shaft 7 and the holder 9 rotates upon pulling the pulling line. The shaft 7 and holder 9 this way provides, via the interconnecting elements 13, a coupling by which the carrier 6 is brought into a rotation-transferring engagement with the line pulley 2 for co-rotation there with. If appropriate, the interconnecting elements such as heels/recesses may be formed with guiding formations which are operative to provide compensation for any misalignment between the carrier and the holder upon connection.

A transmission gear is arranged on the shaft 7, between the line pulley 2 and the carrier 6. In the illustrated embodiment, the transmission gear comprises a bevel gear 14 stationary attached to the line pulley 2. A corresponding bevel gear 15, facing the bevel gear 14, is stationary supported on the carrier 6. A couple of small idling pinion gears 16 are supported in mutually opposite positions in the housing 1, and arranged to engage between the bevel gears 14,15. The axial position of the carrier 6 is adjustable on the shaft 7 by means of a shifting mechanism 17, in the drawings illustrated diagrammatically through a sliding shifter 17 which reaches through the housing wall to the outside of the housing. The sliding shifter is arranged for sliding engagement with the carrier 6 as the carrier rotates in the shifting mechanism. By operation of the sliding shifter the carrier 6 is axially displaceable on the shaft 7 until the bevel gear 15 of the carrier is brought into engagement with the pinion gears 16, such that the carrier is put into a rotation-transferring engagement with the line pulley 2 and rotated in a direction which is contrary to the rotational direction of the line pulley.

Instead of teeth on bevel gears as suggested in the illustrated embodiment, corresponding transmission means may alternatively comprise contact surfaces of other shape, such as surfaces otherwise shaped for frictional engagement.

A helical spring 18 is preferably arranged on the shaft 7, operating between the line pulley 2 and the carrier 6 for biasing the carrier into engagement with the holder 9.

As is already mentioned the carrier 6 carries at least two pawls 5,5′ each operating in one of the co-rotational and contra-rotational directions, respectively. The pawls 5,5′ may be realized as pivoting catch levers. The pawls 5,5, are driven upon rotation of the carrier, through centrifugal force or spring action, to swing an outer end thereof radially outwards from the carrier periphery. In the pivoted operative position, an outer end 22 of the subject pawl engages into an aperture 19 formed in the wall of a cylindrical cap 20, which is stationary attached to the engine crank shaft in concentric relation about the carrier 6.

According to the invention, the carrier 6 carries at least two pawls 5 and 5′ respectively, which are separated in the longitudinal direction of the shaft 7. The pawls 5,5, are pivotally supported on separate sides of a disc 21 which is stationary attached to the carrier 6. The pawls 5,5′ are reversely arranged such that their outer ends 22 swing at mutually opposite directions, when the pawls are pivoted into operative engagement with an aperture 19. Each pawl is carried on a pivot 23, each pivot 23 carrying a spring member arranged between the disc 21 and each pawl 5,5′. This spring member is operative for biasing the corresponding pawl towards a non-engaging position, wherein the pawl's outer end is located radially inside the wall surface of the cylindrical cap 20, out of engagement with a corresponding aperture 19. Each pawl 5,5′ is associated with a triggering spring 24 which is frictionally arrested and caused to rotate relative to the carrier 6 upon rotation thereof. The triggering spring 24 has a leg 25 which is swung into contact with the associated pawl and operative for extending the pawl's outer end 22 upon, rotation of the carrier 6.

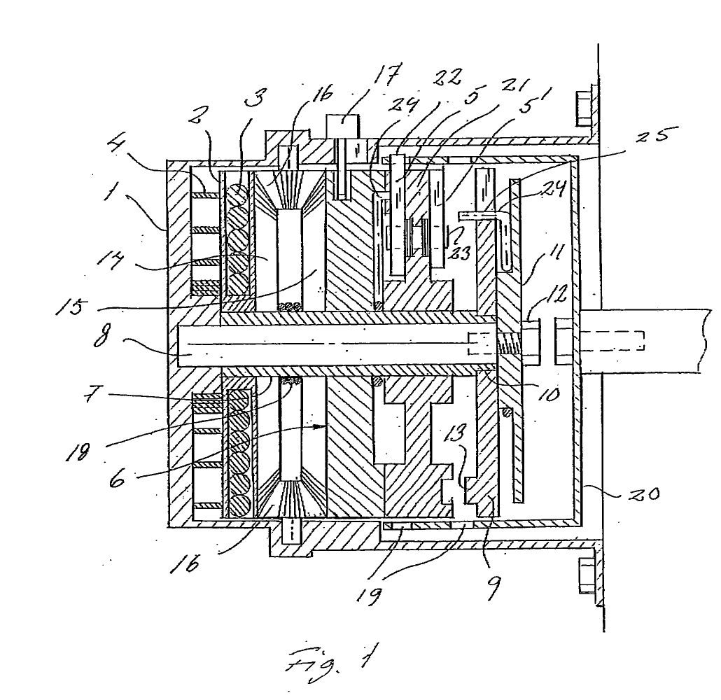

FIG. 1 shows the operation of a pawl 5, carried on that side of disc 21 which is facing towards the line pulley 2, upon starting the engine in a rotational direction which is contrary to the direction of rotation of the line pulley 2 upon pulling the pulling line 3. This pawl 5 is associated with a triggering spring 24 that is frictionally arrested on the rotary shaft 7. Upon rotation of the line pulley 2, the carrier 6 and disc 21 are driven to rotate about the shaft 7 through engagement with the line pulley via the transmission gear, contrary to the rotational direction of line pulley and rotary shaft 7. The triggering spring 24 is forced by the frictional engagement with rotary shaft 7 to rotate together with the shaft 7, until the leg 25 is caught by the pawl 5, in result of which the pawl 5 is triggered to pivot and to engage by its outer end 22 one of the apertures 19 formed through the wall of the cap 20, thus transferring the rotation of the carrier 6 upon the cap and the crank shaft.

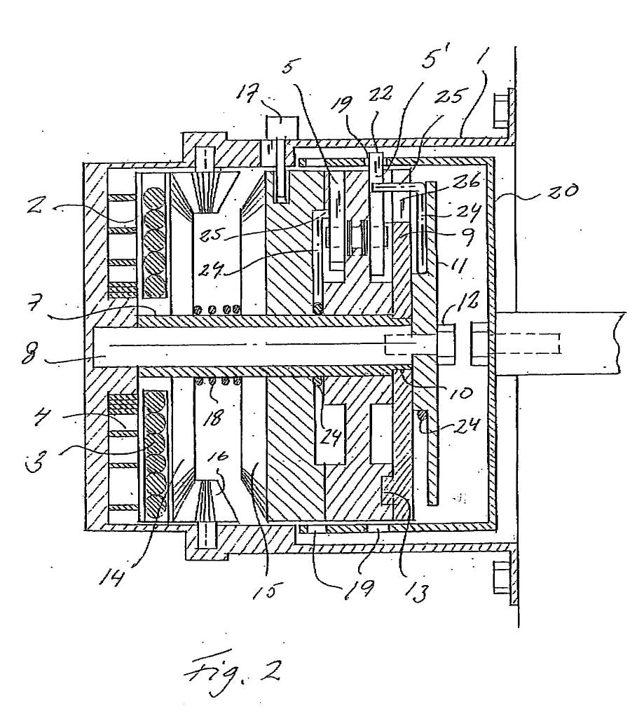

FIG. 2 shows the operation of a pawl 5′, carried on that side of disc 21 which is facing from the line pulley 2 and towards the holder 9, upon starting the engine in a rotational direction which corresponds with the direction of rotation of the line pulley 2 upon pulling the pulling line 3. This pawl 5′ is associated with a triggering spring 24 that is frictionally arrested on the washer 11 and which has a leg 25 that reaches through the holder 9, such as through a slot 26 formed through the holder 9. Upon rotation of the line pulley 2, the carrier 6 and disc 21 are driven to rotate co-directionally with the line pulley and rotary shaft 7 in result of the mechanical connection established with the line pulley via the holder 9. The triggering spring 24 remains stationary on the washer until the pawl 5′ engages the leg 25 of the trigger spring, in result of which the pawl 5 is triggered to pivot and to engage by its outer end 22 one of the apertures 19 formed through the wall of the cap 20, thus transferring the rotation of the carrier 6 upon the cap and the crank shaft. The triggering spring is driven by the pawl 5′ to rotate on the washer 11 against the friction force, as long as the line pulley is caused to rotate by pulling the pulling line.

In order to fulfil its dual purposes, the cap 20 has at least two axially separated apertures 19. Preferably, the cap has two axially separated, rows of apertures 19 running about the periphery of the cap wall. The axial distance between the two rows of apertures 19 is adapted to the axial shifting of the carrier 6 upon the rotary shaft 7, whereby the pawl 5 is caused to rotate inside a non-broken cylindrical wall section upon starting the engine in a co-directional rotation with the line pulley, and whereby the pawl 5′ in the reverse is caused to rotate inside a non-broken cylindrical wall section upon starting the engine in a contra-directional rotation with the line pulley.

Naturally, a recoil starter according to the present invention, which is reversible for starting the engine in one direction of rotation or optionally in the opposite direction of rotation, will have to be assisted by an adjustable ignition system wherein the point of ignition can be angularly displaced relative to the upper dead centre. The shifting of point of ignition to either side of the upper dead centre is achievable by programming an electronic ignition system. In a magnetic ignition system, the shifting may be realized through a second current collector which is optionally insertable at an angularly displaced position in temporary replacement of a first current collector. The electrical adaptation of the engine's ignition system is however a matter of structural concern, for a man skilled in the art of motor control, to be realized in one of a number of possible and suitable ways, each of which takes advantage of the mechanical solution disclosed herein.

1-7. (canceled)

8. A recoil starter comprising:
a housing (1) that is stationary mounted relative to an engine;
a moving unit rotatable about a stationary axis (8) of rotation in the housing, the moving unit comprising a line pulley (2) onto which a pulling line (3) is winded, an inner end of the pulling line being anchored near a centre of the line pulley (2) and an outer, free end of which reaches through an aperture formed through a wall of the housing (1); a return spring (4) connected to the line pulley (2), said return spring arranged to be stretched by the line pulley when the line pulley is rotated about said axis (8) in result of pulling the pulling line (3) off from the line pulley, and which is operative upon return to rewind the pulling line onto the line pulley; a carrier (6) driven by said line pulley for rotation about said stationary axis (8); a swinging pawl (5) supported on the carrier (6), said pawl driven by said carrier in rotation to engage a crank shaft of the engine for transferring upon said crank shaft the rotation of said carrier (6), and which pawl returns to a non-engaging position on said carrier when the rotational speed of the crank shaft exceeds the rotational speed of the carrier upon ignition of the engine, wherein the carrier is shiftable from contra-rotation to co-rotation with the line pulley and vice versa, and the carrier carries at least two pawls, each of which is operative in one of said co-rotational and contra-rotational directions.

9. The recoil starter of claim 8, wherein the carrier (6) is axially displaceable along said axis of rotation, and in a first position of displacement operatively connectable to the line pulley in a co-rotating relation via a mechanical coupling, and in a second position of displacement operatively connectable to the line pulley in a contra-rotating relation via a transmission gear.

10. The recoil starter of claim 9, comprising a hollow shaft (7) which is journalled for rotation about the stationary axis (8), said shaft (7) having a first end carrying the line pulley (2) and a second end carrying a holder (9), wherein the carrier (6) is rotatably supported for sliding on said shaft (7) between the line pulley and the holder, and wherein the carrier is connectable to the line pulley, on one hand, via the transmission gear which is positioned between the carrier and the line pulley and operative for connecting the carrier to the line pulley in a contra-rotational relation, and on the other hand via the mechanical coupling which is positioned between the carrier and the holder and operative for connecting the carrier to the line pulley in a co-rotational relation.

11. The recoil starter of claim 10, wherein the mechanical coupling comprises interconnecting formations (13) formed on that, side of the holder (9) which faces the carrier (6), said interconnecting formations mating in connected position with corresponding formations formed on the carrier.

12. The recoil starter of claim 11, wherein the interconnecting elements are heels and recesses.

13. The recoil starter of claim 10, wherein the transmission gear comprises a first bevel gear (14) on the line pulley (12) facing the carrier (6), and a second bevel gear (15) on the carrier facing the line pulley, and interconnecting pinion gears (16) journalled in the housing wall.

14. The recoil starter of claim 10, comprising a shifting mechanism (17) operative for displacement of the carrier (6) between the co-rotational and contra-rotational positions on the shaft (7).

15. The recoil starter of claim 14, wherein the shifting mechanism comprises a shifter (17) reaching through the housing wall and engaging the carrier (6) in sliding contact.

16. The recoil starter of claim 15, comprising a helical spring (18) supported on the shaft (7) to act between the line pulley (2) and the carrier (6), said spring biasing the carrier from the transmission gear towards the mechanical coupling with the holder (9), into the co-rotational relation with the line pulley.

17. The recoil starter of claim 8, comprising two pawls (5,5′) pivotally supported in axially spaced relation on the carrier (6), each said pawl having an outer end (22) which is forced upon rotation of the carrier to swing radially outwards from the carrier periphery into engagement with corresponding apertures (19) formed in a cap (20) which is connected to the crank shaft in concentric relation about the carrier, said cap (20) comprising a cylindrical wall having two axially separated rows of apertures (19) running about the cylindrical wall, wherein one of said two pawls engages an aperture in one of said rows upon rotation of the carrier in the co-rotational direction, and the other pawl engages an aperture in the other row of apertures upon rotation of the carrier in the contra-rotational direction.

18. The recoil starter of claim 17, wherein each said pawl (5,5′) is associated with a separate, frictionally arrested trigger spring (24), active upon rotation of the carrier for pivoting the corresponding pawl into the operative engagement with the cap (20) and the crank shaft.
